(19) United States
(12) Patent Application Publication
(10) Pub. No.: US 2023/0243499 A1
(43) Pub. Date: Aug. 3, 2023

(54) LOW TEMPERATURE HEAT EXCHANGING SYSTEM AND METHOD FOR A HEAT RECOVERY STEAM GENERATOR

(71) Applicant: NOOTER/ERIKSEN, INC., Fenton, MO (US)

(72) Inventor: Elio Gabriele MAZZI, Gorla Minore (IT)

(21) Appl. No.: 18/011,722

(22) PCT Filed: Sep. 21, 2021
(86) PCT No.: PCT/US2021/051287

§ 371 Date: Dec. 22, 2022

Related U.S. Application Data
(60) Provisional application No. 63/092,247, filed on Oct. 15, 2020.

(51) Int. Cl. F22B 1/18; F22D 1/02; F22D 1/00; F01K 23/10; F02C 6/18; F22B 37/10

(52) U.S. Cl. CPC F22B 1/1807; F22D 1/02; F22D 1/003; F01K 23/10; F02C 6/18; F22B 37/10

(57) ABSTRACT

Heat recovery steam generator-method, comprising a casing, upstream coils of heat exchanger tubes downstream from casing inlet, one or more feedwater heater coils in casing downstream from upstream coils, one or more low temperature heat exchanging coils in casing downstream from upstream coils, one or more low temperature heat exchanging coils within casing comprising corrosion-resistant, thermally conductive graphite component-thermoplastic polymer component composite material, a first flow conduit extending from low temperature heat exchanging coil to feedwater heater coil for water to flow from low temperature coil to feedwater heater coil; and second conduit extending from one or more feedwater heater coils to one or more of the upstream coils for flow from feedwater heater coil to one or more upstream coils, so gas passing through inlet passes through upstream coils through one or more feedwater heater coils and then through one or more low temperature coils.

### RELATED APPLICATIONS

This application claims priority to US Provisional Appl. No. 63/092,247 filed Oct. 15, 2020 which is incorporated herein by reference.

### STATEMENT REGARDING FEDERALLY SPONSORED RESEARCH

Not Applicable.

### BACKGROUND OF THE DISCLOSURE

Natural gas serves as the energy source for much of the currently generated electricity. Electricity can be generated in the environment of a Combined Cycle Power Plant (“CCPP”) system. CCPP systems typically have a life of about twenty-five to thirty years. To this end, the gas undergoes combustion in a gas turbine which powers an electrical generator. However, the products of combustion leave the gas turbine as an exhaust gas quite high in temperature. In other words, the exhaust gas represents an energy source itself. This energy is captured in a heat recovery steam generator (“HRSG”). The gas turbine discharges exhaust gas at an elevated temperature to flow into the HRSG. The HRSG extracts heat from the exhaust gas to convert subcooled liquid water into superheated steam, usually at several pressures. The steam powers a steam turbine which in turn drives a second electrical generator.

Such exhaust gas includes carbon dioxide and water in the vapor phase. When the temperature of the water on the outside of the coldest tubes in the exhaust gas drops below the dew point of water, water condensation on the HRSG tubes occurs. Such water condensation can corrode the tubes, as well as corrode tube fins.

Moreover, such exhaust gas can include traces of sulfur in the form of sulfur dioxide and trioxide. Those sulfur compounds, if combined with water, produce sulfuric acid which is highly corrosive. As long as the temperatures of the heating surfaces remain above the acid dew point temperature of the exhaust gas, SO2 and SO3 pass through the HRSG without harmful effects. But if any surface drops to a temperature below the acid dew point temperature, sulfuric acid will condense on that surface and corrode it.

Dew point temperatures vary depending on the fuel that is consumed. For natural gas the temperature of the heating surfaces should not fall below about 140° F. For most fuel oils it should not fall below about 235° F.

Generally, an HRSG comprises a casing having an inlet and an outlet and a succession of heat exchangers—namely a superheater, an evaporator, and a feedwater heater arranged in that order within the casing between the inlet and outlet. Economizers can also be present in the succession of heat exchangers and there may be multiple evaporators, economizers, and feedwater heaters. The feedwater heater is the last in the succession of heat exchangers in the direction of exhaust gas flow. That feedwater heater receives condensate that is derived from low pressure steam discharged by the steam turbine. The feedwater heater elevates the temperature of the water before the water is discharged into one or more evaporators that convert it into saturated steam. Superheaters in turn convert the saturated steam to superheated steam that powers the steam turbine.

Still generally speaking, in the above-discussed process, most HRSGs produce superheated steam at three pressure levels—low pressure (LP), intermediate pressure (IP) and high pressure (HP). Further and more specifically, an HRSG can have what are termed an LP Evaporator, an HP Economizer, and an IP Economizer. The feedwater heater typically discharges some of the heated feedwater directly into an LP evaporator.

Surfaces vulnerable to corrosion by water and sulphuric acid do exist on the feedwater heater. In the foregoing process, by the time the hot gas reaches the feedwater heater at the back end of the HRSG, its temperature is relatively low. However, that temperature should not be so low that acids condense on the heating surfaces of the feedwater heater.

In overall review, the aforesaid feedwater heater, or preheater, thus extracts heat from low temperature gases to increase the temperature of the incoming condensate before it is directed upstream such as to the LP evaporator, HP economizer, or IP economizer. Multiple methods and equipment have been used to increase the temperature of the condensate before it enters any part of the feedwater heater or preheater tubes within the gas path. Such methods and equipment have included, for example, a recirculation pump and a heat exchanger located to the exterior of the HRSG exhaust gas flow path (“external heat exchanger”). Such additional equipment and methods are used to prevent the exhaust gas temperature from dropping below the acid dew point and causing water corrosion and sulfuric acid corrosion.

Prior systems and methods have been limited in application because the feedwater temperature was not high enough to protect against dew point corrosion of all fuels. The movement of the heat transfer coils to the hotter regions provides for higher differentials in the heat exchanger.

Prior art configurations with feedwater heaters to direct fluid flow of water and steam include U.S. Pat. No. 6,508,206 B1 (hereafter “'206 Patent”) which is hereby incorporated by reference in this application as if fully set forth herein. The '206 Patent employs two feedwater heaters 26 and 28. FIG. 3 of the '206 Patent illustrates a gas turbine G that discharges hot exhaust gases into an HRSG A which extracts heat from the gases to produce steam to power a steam turbine S. The gas turbine G and steam turbine S power the electrical generators E. The steam turbine S discharges steam at a low temperature and pressure into a condenser 2 where it is condensed into liquid water. Then a condensate pump 4 directs that water back to a water-to-water heat exchanger 34 that is external to the HRSG. That external heat exchanger 34 heats that lower temperature condensate with the source of heat being hot water that exits the aforesaid feedwater heater 26. In doing so the condensate flow first enters the external heat exchanger 34 where it is heated by the water flowing from feedwater heater 26. Then the preheated condensate leaves the external heat exchanger 34 and enters the other feedwater heater 28. There it is further heated and then flows through pipe 48 to the evaporator 18 to be converted to saturated steam.

Another example of HRSG prior art that uses a pump and external water-to-water heat exchangers to preheat water entering a feedwater heater is disclosed in U.S. Pat. No. 10,180,086 (“'086 Patent) which is hereby incorporated by reference in this application as if fully set forth herein. In the '086 Patent a preheater booster coil is positioned in a hotter section of the exhaust gas flow, upstream of the LP evaporator, to achieve the beneficial result of increasing source inlet temperature and directly increasing the outlet temperature of the preheated condensate exiting the external heat exchanger. This arrangement allows the use of an external heat exchanger in designs with higher dew points in the cold end to create a larger temperature differential in the external water-to-water heat exchanger and protects the HRSG from cold end condensation corrosion from fuels with higher acid dew points. FIGS. 3, 4 and 5 of the '086 Patent illustrate three different arrangements, respectively showing two feedwater heaters 103 and 106, three feedwater heaters 210, 213 and 216; and one feedwater heater 106″. In each embodiment water flows from a pump 52 to a condenser 51 then respectively to the external heat exchanger 125, 125′ or 125″, to be heated by fluid flowing from the preheater booster coil. Thence the condensate water flows through respective feedwater heater(s) and thereafter is directed to upstream coils.

Prior art systems and methods have thus been faced with use of equipment and methods such as water-to-water heat exchangers and their enclosures and interconnecting pipes and flows with feedwater heaters and other coils to avoid the problems of water condensation and sulphuric acid damage. Further prior art systems and methods have had to use heat from the HRSG to preheat the incoming condensate. Neither carbon steel nor other low allow metal materials have been proven to resist water or sulfuric acid corrosion attack.

### SUMMARY OF THE DISCLOSURE

In the disclosure of the present system and method, condensate water from a condenser is in flow connection with a low temperature heat exchanger that is located in the HRSG flow path at a position downstream of the feedwater heater or heaters, and thus in a relatively cooler location of the HRSG. The low temperature exchanger can comprise a coil or multiple coils that can be composed of chemical resistant thermoplastic polymeric materials that are not sensitive to corrosion induced by water or acid condensation. These materials are heat conductive such as heat conductive polypropylene (PP-GR) or heat conductive polyphenylene sulfide (PPS-GR). A heat conductive graphite filler can be interspersed therein. The composite materials for such coils, because of their structural role in providing support to the low temperature coils under pressurized conditions, are also be temperature resistant under the subjected operating temperatures. The materials and construction of such coils is strong enough to withstand the operating pressures to which they are subjected.

In operation, condensate water from the condenser is directed to flow into the inlet of the low temperature coil. The said condensate water within the low temperature coil is then heated by the turbine exhaust gas that flows by the low temperature coil. The water is then discharged from the low temperature coil to flow to upstream coils such as to the inlet of one or more feedwater heater coils. Water directed into one or more feedwater heater coils is further heated and then flows to one or more upstream coils such an evaporator or economizer. The turbine exhaust gas that flows by the low temperature coil can then flow toward the HRSG outlet to be discharge through the flue.

The present disclosure avoids or minimizes the use of water-to-water heat exchangers and their associated enclosures, vessels and pipes in directing water to feedwater heaters. By such construction and by the location of the low temperature coil in the exhaust gas flow path there is increased energy recovery by the HRSG, and improved heat exchange cycle efficiency. The construction and composition of the low temperature coils resists corrosion from condensation of water or sulfuric acid on the tubes of the low temperature coil. Such improvements better allow an HRSG to resist corrosion damage and survive for the lifetime of a Combined Cycle Power Plant (“CCPP”).

The foregoing and other features and advantages of the disclosure as well as presently preferred embodiments thereof will become more apparent from the reading of the following description in connection with the accompanying drawings.

### BRIEF DESCRIPTION OF DRAWINGS

FIG. 1 is a schematic view of a power system that uses a heat recovery steam generator (“HRSG”) of the present disclosure;

FIG. 2 is a sectional view of a novel HRSG;

FIG. 3 is a sectional view of a novel HRSG, which differs from FIG. 2 in that it shows an embodiment that includes a preheater booster coil;

FIG. 4 is a schematic view of elements of a novel HRSG;

FIG. 5 is a schematic view of elements of another embodiment of a novel HRSG;

FIG. 6 is a schematic view of elements of yet another embodiment of a novel HRSG wherein an external heat exchanger for feedwater is also employed;

FIG. 7 is a schematic view of elements of a further embodiment of a novel HRSG wherein an external heat exchanger for feedwater is employed;

FIG. 8 is a schematic view of elements of another embodiment of a novel HRSG wherein the low temperature heat exchanger is mounted to the sidewalls of the HRSG;

FIG. 9 is a cross-sectional view of the novel HRSG of FIG. 8 showing the coils of the low temperature heat exchanger adjacent the HRSG sidewalls;

FIG. 10 is a schematic view of elements of another embodiment of a novel HRSG wherein the low temperature heat exchanger is mounted to the sidewalls of the HRSG wherein an external heat exchanger for feedwater is also employed; and

FIG. 11 is a schematic view of elements of a further embodiment of a novel HRSG wherein the low temperature heat exchanger is mounted to the sidewalls of the HRSG and an external heat exchanger for feedwater is also employed.

Corresponding reference numerals indicate corresponding parts throughout the several figures of the drawings.

### DESCRIPTION OF EMBODIMENTS

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of the disclosure. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

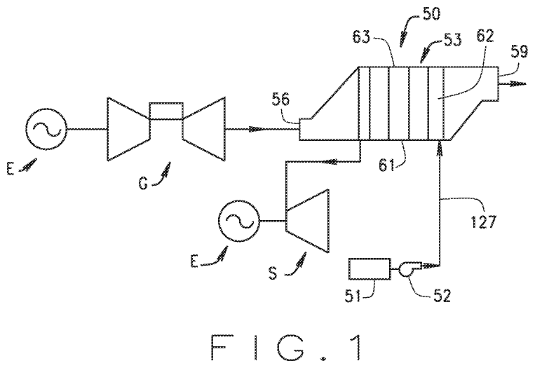

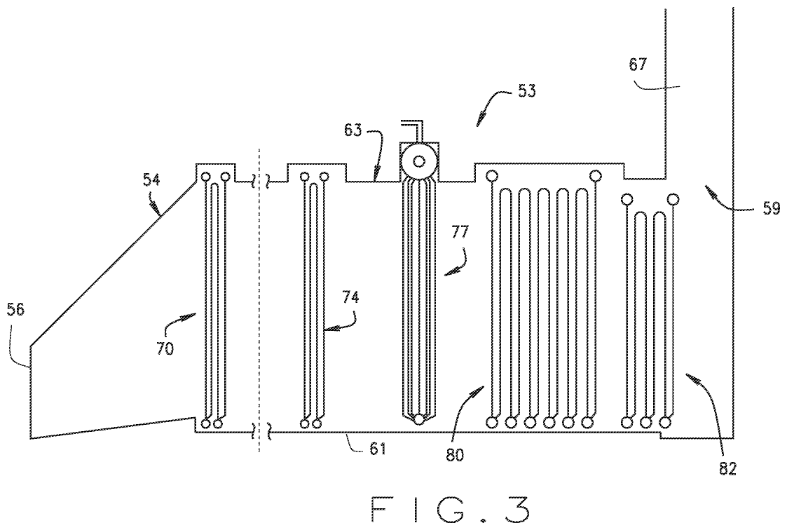

The disclosures are now provided for a heat exchanging system and method for an HRSG. An overall illustration of a power system which features use of a heat-recovery steam generator (HRSG) appears in the aforementioned U.S. Pat. No. 6,508,206 B1 (the “'206 Patent”). The '206 Patent is hereby incorporated by reference in this application as if fully set forth herein. FIG. 1 of the present application shows a layout similar to that shown in FIG. 3 of the '206 Patent, but lacking an external water-to-water heat exchanger shown as 34 in the '206 Patent.

FIG. 1 hereof discloses a gas turbine G that discharges hot exhaust gases into an HRSG 50, which extracts heat from the gases to produce steam to power a steam turbine S. The gas turbine G and steam turbine S power the generators E that are capable of producing electrical energy. The steam turbine S discharges steam at a low temperature and pressure into a condenser 51 where it is condensed into liquid water. The condenser 51 is in flow connection with a condensate pump 52 that directs the water back to the HRSG 50 as feedwater through a flow conduit 127.

The disclosure of the present application shows an HRSG 50 with an arrangement of heat exchangers and flow channels that provide improvements over the prior art.

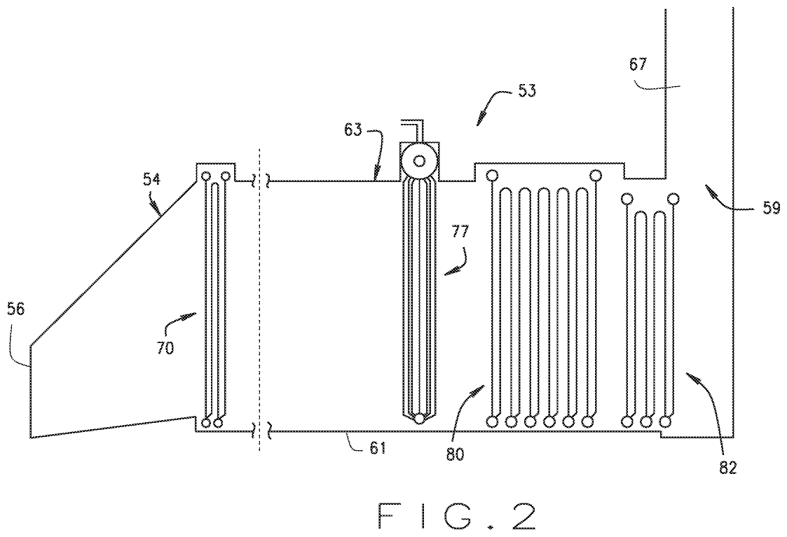

With reference to FIGS. 1 and 2 of the present application, the HRSG 50 has a casing 53 within which are heat exchangers. Hot gases, such as discharged from a gas turbine, enter the casing 53 and pass through a duct 54 having an inlet 56 and an outlet 59. During that process, the hot gases pass through heat exchangers.

The casing 53 generally will have a floor 61 over which the heat exchangers are supported, and sidewalls 62 that extend upwardly from the floor 61. Typically, the top of the casing 53 is closed by a roof 63. The floor 61 and roof 63 extend between the sidewalls 62 so that the floor 61, sidewalls 62 and roof 63 help to form the duct 54. From outlet 59 the gas can flow through flue 67.

Generally, the heat exchangers comprise coils that have a multitude of tubes that usually are oriented vertically and arranged one after the other transversely across the interior of the casing 53. The coils are also arranged in rows located one after the other in the direction of the hot gas flow depicted by the arrows in FIG. 3 of the present application. The tubes contain water in whatever phase its coils are designed to accommodate. The length of the tubes can be as great as 80′ tall.

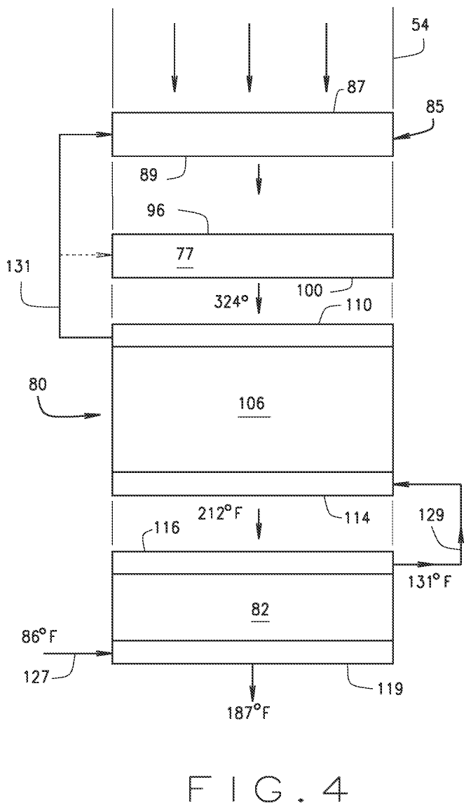

Now attention is directed to the arrangement of the heat exchangers shown in the embodiment shown in FIG. 2. The general description for FIG. 2 will be given with an orientation of moving from the inlet 56 to the outlet 59, or from the left to the right looking at FIG. 2. Generally, reference character 70 represents what are termed “Upstream Coils” in an HRSG. For example, such Upstream Coils can include what are referred to in the '206 Patent, as a superheater designated by reference character 16 in the '206 Patent that converts saturated steam to superheated steam; followed by at least one evaporator such as a high-pressure evaporator (“HP Evaporator”) shown as 18 in the '206 Patent; thence followed by a high-pressure economizer (“HP Economizer”). The HP Economizer is shown as a group of coils immediately to the right of the evaporator designated 18 and shown in FIG. 4 of the '206 Patent. Other coils, such as an Intermediate Pressure (IP) Economizer and Intermediate Pressure (IP) Evaporator may be downstream therefrom. Hence the term “Upstream Coils 70” with reference to FIG. 2, as well as FIG. 3, herein generally refers to all of the Superheater, HP Evaporator and HP Economizer and any intermediate coils such as the IP Economizer and IP Evaporator. The amount of the space devoted to such components in the HRSG can depend upon the desired characteristics and performance of the HRSG 50.

Downstream from the Upstream Coils 70, appears a low-pressure evaporator 77 (“LP Evaporator”). Thence downstream from the LP Evaporator is what is generally designated as a feedwater heater 80.

Then downstream from feedwater heater 80 is the low temperature heater exchanger 82.

Now the alternate embodiment of FIG. 3 will be described. FIG. 3 differs from FIG. 2 in that downstream from the Upstream Coils 70, is a preheater booster 74. The preheater booster 74 provides for a feedwater heater presence in a hotter region of the HRSG to facilitate return feeding therefrom to a heat exchanger that feeds water to other parts of the feedwater heater. As noted earlier such a preheater booster is disclosed in U.S. Pat. No. 10,180,086 (“'086 Patent) which is hereby incorporated by reference in this application as if fully set forth herein.

Continuing the description from upstream to downstream, left to right in FIG. 3, downstream from preheater booster 74 appears the low-pressure evaporator 77 (“LP Evaporator”). Thence downstream from the LP Evaporator 77 is what is generally designated a feedwater heater 80.

Now, with more specific reference to the schematic view of FIG. 4 which corresponds to the FIG. 2 embodiment, the exhaust gases from the gas turbine “G”, enter the upstream face 87 of the last of the Upstream Coils 70, here designated, for example, as a high pressure (HP) economizer 85. The exhaust gases enter the HP Economizer upstream face 87 and exit the downstream face 89 of HP Economizer 85.

As seen in the FIG. 4 schematic, the LP Evaporator 77 has an upstream face 96 and a downstream face 100. The exhaust gas leaves the downstream face 89 of HP Economizer 85 thence flows into the LP Evaporator 77 upstream face 96, through the LP Evaporator 77, and through the LP Evaporator's downstream face 100 toward the feedwater heater 80.

The feedwater heater 80 has an upstream face 110 and a downstream face 114. The exhaust gases from the LP Evaporator 77 flow into the upstream face 110, then through the coils of feedwater heater 80, thence exit through the downstream face 114.

The low temperature exchanger 82 has an upstream face 116 and a downstream face 119. The exhaust gases from feedwater heater 80 flow into the upstream face 116, then through the coils of low temperature exchanger 82, thence exit through the downstream face 119. From there, the exhaust gases can flow through outlet 59 and exit flue 67.

The low temperature coils for the HRSG system can be composed of composite materials comprising a graphite-based element combined with thermoplastic polymeric materials that, as a composite, are chemically resistant to corrosion induced by water and/or acid condensation, such as sulfuric acid derivatives of sulfur dioxide/trioxide components that result from condensation that occurs within certain temperatures. These materials are thermally conductive, such as heat conductive polypropylene graphite (PP-GR) or heat conductive polyphenylene sulfide graphite (PPS-GR). Such PP-GR and PPS-GR materials can be formulated by distribution of the graphite particles within a thermoplastic polymeric matrix, and are commercially available from Technoform (Technoform Tailored Solutions Holding Gmbh, An den Lindenbaumen 17; 34277 Fuldabruck, Germany. https://www.technoform.com/. With the characteristics of the materials understood to meet the criteria of this disclosure for providing the enhanced low temperature coils of the disclosure, it will be understood that other similar composite materials can be selected from commercial sources or prepared by methods for the production thereof and tested for their adequacy of performance as outlined below.

Additionally, the composite materials, because of their structural role in providing support to the low temperature coils under pressurized conditions, should also be generally temperature resistant, e.g., up to a temperature of about 200° C. to about 230 ° C. and structural stability and strength, e.g., up to against a crushing force of about 30 barg.

The material composite comprises (a) from about 70 wt. % to about 90 wt. % of a graphite-based element and (b) from about 30 wt. % to about 10 wt. % of a thermoplastic polymer element.

The graphite-based element for impregnated graphite is generally “raw” graphite, but can include graphite that has been treated in some manner not inconsistent with producing the characteristics of the instant composite.

The thermoplastic polymer component also can be drawn from any thermoplastic polymeric material that has the corrosion resistance and meets the thermal conductivity parameters and any other material performance requirements when formulated into the graphite composite material, and is therefore suitable for use as described above. These may include polyolefins, such as the polypropylene described above, as well as polyaryl sulfides, such as polyphenylene sulfide, described above, if they meet the performance requirements outlined herein.

The suitability of various thermoplastic polymer-graphite composites can be tested using known testing protocols. For example, such performance criteria testing can include:

for water-related corrosion resistance: ASME Hydro test;

for sulfuric acid-related corrosion resistance: such as immersion in sulfuric acid with appropriate concentration and heat treatment

Thermal conductivity: ASTM E-1461

Pressure stability: evaluation using testing consistent with ASME Code VIII Sec.1, Part UIG, Table UIG-6-1.

These and other testing protocols known to those skilled in the art can be used.

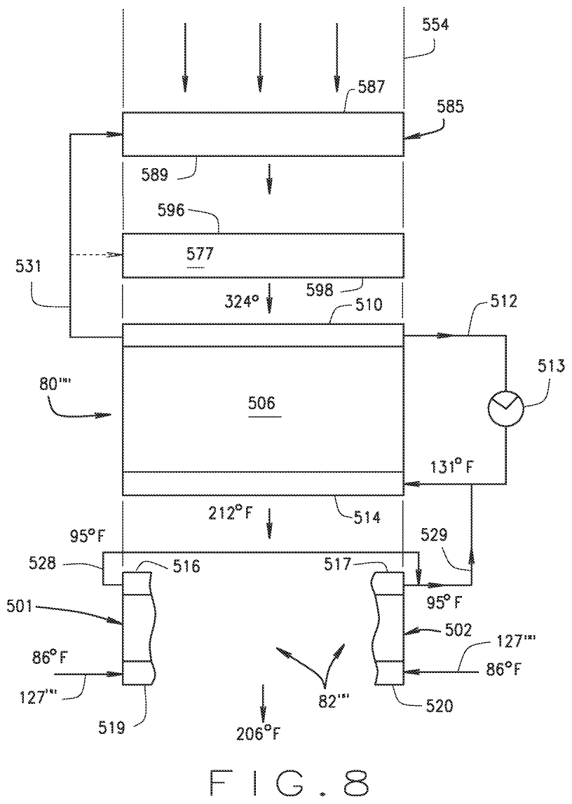

From the mechanical point of view, the low temperature coil 82″ is located in the outlet duct of the HRSG in the flue gas path cooling down the coldest exhaust gas before entering the stack and is composed of commercial length thermoplastic tubes connected to top, intermediate and bottom headers as necessary to fill in the complete height and width of the duct where the exhaust gas flows. Piping nozzles are located on the top and bottom headers of 82″ coil to connect the coil to the external feedwater metallic piping. The low temperature coil 82″, with a similar geometrical arrangement, can also be installed on the two sides of the HRSG outlet duct as described in FIGS. 8-11.

Focusing now on the flow of water/steam among components of the arrangement, and referring first to the embodiment shown in FIGS. 2 and 4, the condensate pump 52 discharges feedwater into supply pipe 127, which delivers that feedwater into the inlet at the downstream face 119 of the low temperature heat exchanger 82. The feedwater then passes through the coil of the low temperature exchanger 82 and exits near upstream face 116 at its outlet to flow into a connecting pipe 129 which acts as a conduit. Pipe 129 then delivers the feedwater to the coil tubes at the downstream face 114 of feedwater heater 106. The water passes through the coil of the feedwater heater 106 to exit near its upstream face 110 to flow through a transfer pipe 138 which acts as a conduit to connect with upstream coils. Alternatively, water exiting from feedwater heater 106 can flow to the inlet of LP Evaporator 77.

Now the system and method will be further discussed with some reference to exemplary temperatures for FIG. 4. Feedwater from the condenser 51 can be discharged at approximately 86° F. through the supply pipe 127 into the inlet near the downstream face 119 of low temperature exchanger 82. The water passes through the low temperature exchanger 82 to exit at its outlet near its upstream face 116 at a temperature of approximately 131° F. From there, the water flows through pipe 129 into an inlet of feedwater heater 82 near feedwater heater 82 downstream face 114 at a temperature of approximately 131° F.

With regard to FIG. 4 and temperatures of the exhaust gases, the exhaust gases flow from the gas turbine “G”, to enter the upstream face 87 of the last of the Upstream Coils 70, here designated, for example, as high pressure (HP) economizer 85. The gases enter the HP Economizer upstream face 87 and exit the downstream face of HP Economizer 89 and enter the upstream face 96 of LP Evaporator 77 to flow therethrough. The hot gases exit the LP Evaporator downstream face 100 at what is shown as an exemplary temperature of about 324° F. to enter the upstream face 110 of feedwater heater section 106 and flow through LP Evaporator 77. The temperature of the hot gas exiting the feedwater heater section 106 at its downstream face 114 is about 212° F.

Thereafter the exhaust gas flows through into the upstream face 116 of low temperature exchanger 82 through the exchanger 82 to exit its downstream face 119 at a temperature pf about 187° F. to flow through HRSG outlet 59 to exit flue 76.

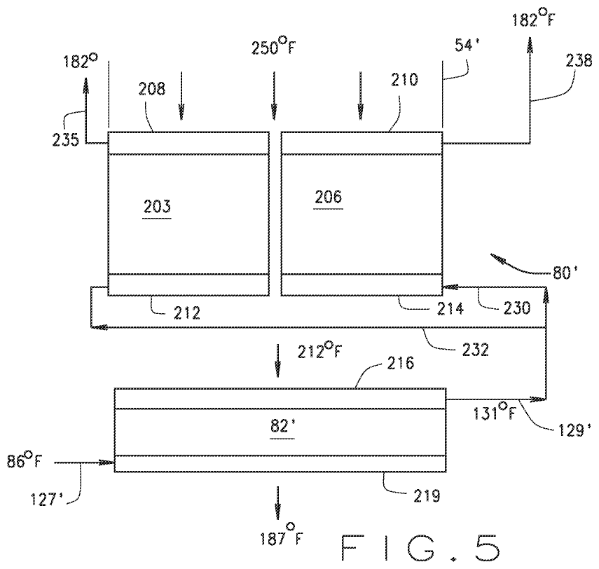

Turning now to the disclosure of FIG. 5, FIG. 5 differs from the disclosure of FIG. 4 in that in FIG. 4 there are two feedwater sections rather than one. Likewise, the FIG. 5 system corresponds to the arrangement in FIG. 2 wherein the booster 74 is absent. As seen in FIG. 5, the feedwater heater 80′ has two sections 203 and 206, which can be arranged side by side in the duct 54′, as shown in FIG. 5. Sections 203 and 206 each have an upstream face 208 and 210, respectively, and downstream faces 212 and 214, respectively. The exhaust gases flow into the upstream faces 208 and 210, then through the coils of sections 203 and 206 respectively, thence exit through the downstream faces 212 and 214, respectively.

Thereafter the exhaust gas flows into the upstream face 216 of low temperature exchanger 82′ through the exchanger 82′ to exit its downstream face 219 at a temperature of about 187° F. to flow through HRSG outlet 59 to exit flue 76. Low temperature exchanger 82′ is comprised of the same thermoplastic polymeric material composition as described above for low temperature exchanger 82.

With regard to water/steam flow in FIG. 5, feedwater from the condenser 51 can be discharged at approximately 86° F. through the supply pipe 127′ into the inlet near the downstream face 219 of low temperature exchanger 82.′ The water passes through the low temperature exchanger 82′ to exit at its outlet near its upstream face 216 at a temperature of approximately 131° F. From there, the water flows through pipe 129′.

Pipe 129′ diverges into two pipes 230 and 232. The water in pipe 230 flows into an inlet of feedwater heater 206 near feedwater heater 206 downstream face 214 at a temperature of approximately 131° F., flows through that feedwater heater and exits feedwater heater 206 near its upstream face 210 into a pipe 238 at a temperature of about 182° F.

As to the other divergent pipe 232, water from it flows into an inlet of feedwater heater 203 near feedwater heater 203 downstream face 212 at a temperature of approximately 131° F. The water then flows through feedwater heater 203, then exits therefrom into pipe 235 at a temperature of about 182° F.

The water exiting feedwater heaters 203 and 206 through pipes 235 and 238, respectively, can flow to upstream coils such as to the LP Evaporator 77 or HP economizer 85.

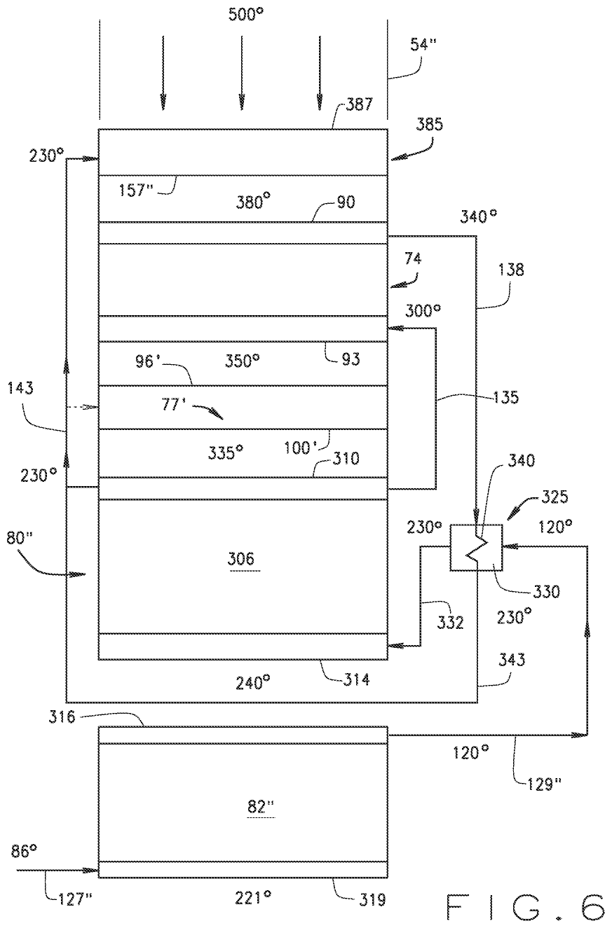

Addressing now the disclosure of FIG. 6, FIG. 6 is like that of FIG. 4 except that it also shows the interface with an external water-to-water heat exchanger and preheater booster coil 74.

The preheater booster 74 comprises a coil having an upstream face 90 and a downstream face 93. The exhaust gases from economizer 385 flow into the upstream face 90 through the coil and thence through the downstream face 93 to leave the preheater booster 74.

As seen in the FIG. 6 schematic, the LP Evaporator 77′ has an upstream face 96′ and a downstream face 100′. The exhaust gas leaves the preheater booster 74 thence flows into the LP Evaporator 77′ upstream face 96, through the LP Evaporator 77′, and through the LP Evaporator's downstream face 100′ toward the feedwater heater 80″.

In FIG. 6 a water-to-water heat exchanger 325 is illustrated as located to the exterior of the HRSG duct 54. The use of such an external water-to water heat exchanger may be desirable in situations wherein it is desire to have a warmer temperature for the water entering the feedwater heater, or when the inlet water from the condenser is lower, or when a refurbishment is performed to add the low temperature heat exchanger to an existing HRSG unit that already has a water-to-water heat exchanger installed.

In FIG. 6 the condensate pump 52 discharges feedwater into a supply pipe 127″, which delivers that feedwater at a temperature of about 86° F. into the inlet near the downstream face 319 of the low temperature heat exchanger 82″. Low temperature exchanger 82″ is comprised of the same thermoplastic polymeric material composition as described above for low temperature exchanger 82.

The water flows through exchanger 82″ and exits through pipe 129″ near the upstream face 316 of low temperature exchanger 82″ at a temperature of about 120° F. The water then flows through pipe 129″ into the low temperature path 330 in external heat exchanger 325 and then flows through an external exchanger outlet at a temperature of about 230° F. into a connecting pipe 332 which acts as a conduit. Pipe 332 delivers the feedwater to the tubes at the downstream face 314 of feedwater heater 80″.

The water/steam leaves the feedwater heater 80″ at its upstream face 310 and flows through a transfer pipe 135 which serves as a conduit to connect with the inlet of the preheater booster 74 coil at its downstream face 93. The water/steam flows thence through preheater booster coil 74 toward the upstream side thereof to exit the preheater booster coil 74 at its upstream face 90 at a temperature of about 340° F. From there, it flows into a transfer pipe 138 which acts as a conduit to connect with the inlet of the high temperature path 340 of heat exchanger 325.

Within the high temperature path 340 of heat exchanger 325 the temperature of the water decreases since it loses heat to water in the low temperature path 330. At the outlet of the high temperature path 340, the water enters transfer pipe 343 at a temperature of about 230° F. Pipe 343 acts as a conduit and extends to connect with the LP Evaporator 77′ at its downstream face 100′, or to the downstream face 157″ of HP economizer 385. If flow is to LP Evaporator 77′, then from the upstream face 96′ of LP Evaporator 77′, the water can flow, for example, to the HP Economizer 385.

As to FIG. 6 and temperatures of the exhaust gases, the exhaust gases flow from the gas turbine “G”, to enter the upstream face 387 of the last of the Upstream Coils 70, here designated, for example, as high pressure (HP) economizer 385, at a temperature of about 500° F. The gases enter the HP Economizer upstream face 387 and exit the downstream face 389 of HP Economizer 385 and enter the preheater booster upstream face 90 and exit its downstream face 93 at a temperature of about 350° F. The exhaust gases from preheater 74 flow into the upstream face 96′ of LP Evaporator 77′ to flow therethrough. The hot gases exit the LP Evaporator downstream face 100′ at what is shown as an exemplary temperature of about 335° F. to enter the upstream face 310 of feedwater heater section 306. The temperature of the hot gas exiting the feedwater heater section 306 at its downstream face 314 is about 240° F.

Thereafter the exhaust gas flows through into the upstream face 316 of low temperature exchanger 82″ through the exchanger 82″ to exit its downstream face 319 at a temperature of about 187° F. to flow through HRSG outlet 59 to exit flue 76.

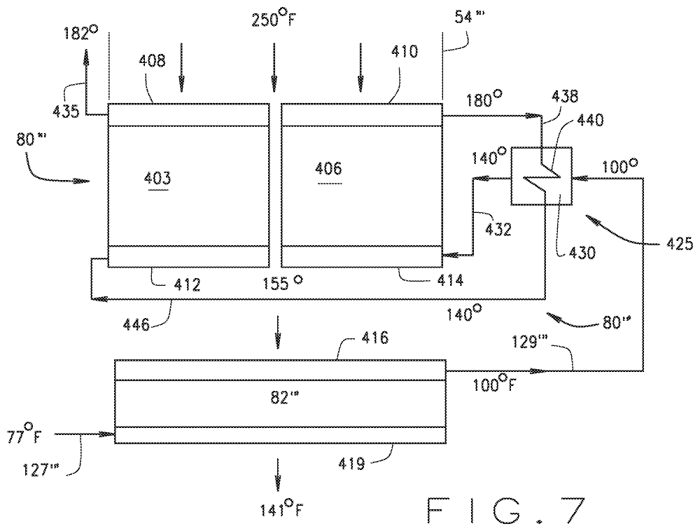

Attention is now turned to the disclosure of FIG. 7 which illustrates a low temperature exchanger 82′″ that is comprised of the same thermoplastic polymeric material composition as described above for low temperature exchanger 82.

FIG. 7 resembles the system of FIG. 5 in that it has a feedwater heater 80′″ with two sections 403 and 406, except that it also shows the interface with an external water-to-water heat exchanger 425. In FIG. 7 the water-to-water heat exchanger 425 is illustrated as located to the exterior of the HRSG duct 54′″. The condensate pump 52 discharges feedwater into a supply pipe 127′″, which delivers that feedwater at a temperature of about 77° F. into the inlet near the downstream face 419 of the low temperature heat exchanger 82′″. That about 77° F. inlet temperature is lower than that described for the examples of FIGS. 5 and 6. So in this FIG. 7 illustration the external water-to-water heat exchanger 425 provides additional heat to water entering at a lower temperature from the condenser 52.

In FIG. 7 the water flows through exchanger 82′″ and exits through pipe 129′″ near the upstream face 416 of exchanger 82′″ at a temperature of about 100° F. The water then flows through pipe 129′″ into the low temperature path 430 in exchanger 425 and is heated. The water then flows to exit through an external exchanger outlet at a temperature of about 140° F. into a connecting pipe 432 which acts as a conduit. Pipe 432 delivers the feedwater to the tubes at the downstream face 414 of feedwater heater section 406. The water/steam leaves the feedwater heater section 406 at its upstream face 410 and flows into the high temperature path 438 of external heat exchanger 425 at a temperature of about of about 180° F. Therein it is cooled to exit into pipe 446 at a temperature of about 140° F.

Then the water flows through pipe 446 into an inlet of feedwater heater section 403 near feedwater heater section 403 downstream face 412 at a temperature of approximately 140° F. The water then flows through feedwater heater section 403, then exits therefrom into pipe 435 at a temperature of about 182° F. The water exiting feedwater heater section 403 through pipe 435 can flow to upstream coils such as to the LP Evaporator 77 or HP economizer 85.

Now the FIG. 7 system will be discussed with exemplary temperatures for the exhaust gases. The exhaust gases from the gas turbine “G”, pass through the various Upstream Coils 70 to enter the feedwater heater sections' upstream faces 408 and 410 at a temperature of about 250° F. The exhaust gases exit those sections' downstream faces 412 and 414 at a temperature of about 155° F. and enter the upstream face 416 of low temperature exchanger 82′″ at about that same temperature. The exhaust gases pass through exchanger 82′″ and exit at its downstream face 419 temperature of about 141° F.

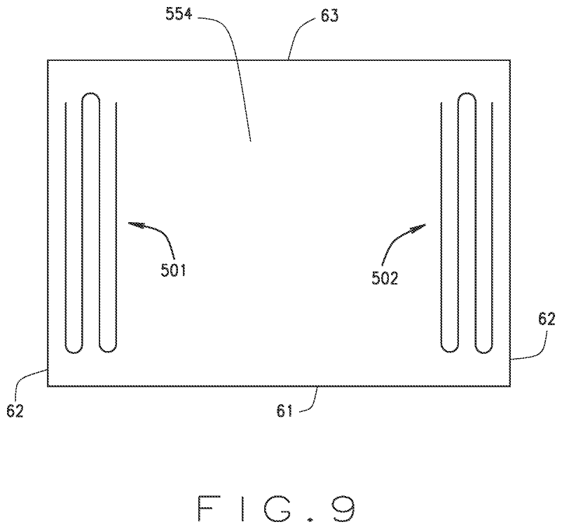

Transitioning to FIGS. 8-11, they concern embodiments of the low temperature heat exchanger being mounted to the sides of an HRSG so that the exhaust gas flows through the duct to pass between two separate coils of the low temperature exchanger as well as to pass through those coils. Turning first to the embodiment of FIGS. 8 and 9, and more specifically now to FIG. 8, the exhaust gases from the gas turbine “G”, enter the upstream face 587 of the last of the Upstream Coils 70, here designated, for example, as a high pressure (HP) economizer 585. The exhaust gases enter the HP Economizer upstream face 587 and exit the downstream face 589 of HP Economizer 585.

As seen in the FIG. 8 schematic, the LP Evaporator 577 has an upstream face 596 and a downstream face 598. The exhaust gas leaves the downstream face 589 of HP Economizer 585 thence flows into the LP Evaporator 577 upstream face 596, through the LP Evaporator 577, and through the LP Evaporator's downstream face 598 toward the feedwater heater 80″″ and its section 506.

The feedwater heater 80″″ has an upstream face 510 and a downstream face 514. The exhaust gases from the LP Evaporator 577 flow into the upstream face 510, then through the coils of feedwater heater 80″″, thence exit through the downstream face 514.

The low temperature exchanger 82″″ has two separate sections 501 and 502 each of which is mounted adjacent respective HRSG sidewalls 62 as illustrated in the HRSG cross-section of FIG. 9. As so mounted, the sections 501 and 502 are spaced a distance from each other so that some of the exhaust gas flows between the two sections 501 and 502. However, some of the exhaust gas also flows through the two sections 501 and 502. As illustrated in FIG. 8, the cross width of each of the sections 501 and 502 can vary depending upon the desired performance characteristics. Low temperature exchanger sections 501 and 502 are comprised of the same thermoplastic polymeric material composition as described above for low temperature exchanger 82.

Looking first at the exhaust gas that flows through each section 501 and 502, each section 501 and 502 has, respectively, an upstream face 516 and 517, and a respective downstream face 519 and 520. The exhaust gases from feedwater heater 80″″ flow into each of the said upstream faces 516 and 517 of sections 501 and 502, respectively, then through the coils of low temperature exchanger section 501 and 502, respectively. Thence the exhaust gas exits through the downstream faces 519 and 520, respectively of sections 501 and 502.

Now addressing the exhaust gas that flows between the two sections 501 and 502, simultaneously with the exhaust gas flow through sections 501 and 502, exhaust gas also flows between the inside boundaries of sections 501 and 502. Considered together, the exhaust gas that flows through sections 501 and 502, and the exhaust gas that flows between those sections 501 and 502, comingle to both flow through outlet 59 and exit flue 67.

The system and method of FIGS. 8 and 9 now will be discussed in the context of exemplary temperatures. Feedwater from the condenser 51 can be discharged at approximately 86° F. through the supply pipes 127″″ into the inlets near each of the downstream faces 519 and 520 of low temperature exchanger sections 519 and 520, respectively. The water passes through the low temperature exchanger sections 501 and 502, to exit at their respective outlets near their respective upstream faces 516 and 517, at a temperature of approximately 95° F. From section 501, the water then flows through pipe 528, while water from section 502 flows into a pipe 529. Pipe 528 merges into flow connection with pipe 529, with the combined flow through pipe 529 merging into flow connection with pipe 512, as will be further explained.

Water flows from pipe 512 into an inlet of feedwater heater 80″″ near feedwater heater 80″″ downstream face 514 at a temperature of approximately 131° F. The water then flows through the coils of feedwater heater 80″″. A portion of the water flow through feedwater heater 80″″ exits near the upstream face 510 of feedwater heater section 80″″ to flow into and through a recirculation pump 513 which pumps water through pipe 512. Thereafter the water flow from pipe 529 merges into pipe 512, and the combined flow then flows into the aforesaid inlet of feedwater heater 80″″ near its downstream face 514 at a temperature of approximately 131° F.

Another portion of the water flowing into and through feedwater heater 80″″ exits near its upstream face 510 into pipe 531 to flow into LP Evaporator 577 and/or HP Economizer 585, or to other Upstream Coils.

With regard to FIGS. 8 and 9 and temperatures of the exhaust gases, the exhaust gases flow from the gas turbine “G”, to enter the upstream face 587 of the last of the Upstream Coils 70, here designated, for example, as high pressure (HP) economizer 585. The gases enter the HP Economizer upstream face 587 and exit the HP Economizer downstream face 589 and enter the upstream face 596 of LP Evaporator 577 to flow therethrough. The hot gases exit the LP Evaporator downstream face 598 at what is shown as an exemplary temperature of about 324° F. to enter the upstream face 510 of feedwater heater section 506 and flow through feedwater heater section 506. The temperature of the hot gas exiting the feedwater heater section 506 at its downstream face 514 is about 212° F.

Thereafter as previously discussed, the exhaust gas flows between the two low temperature exchanger sections 501 and 502, and the exhaust gas also simultaneously flows through sections 501 and 502. The exhaust gas that flows through sections 501 and 502, and the exhaust gas that flows between those sections 501 and 502, comingle to exit low temperature exchanger 82″″ at a temperature of about 206° F.

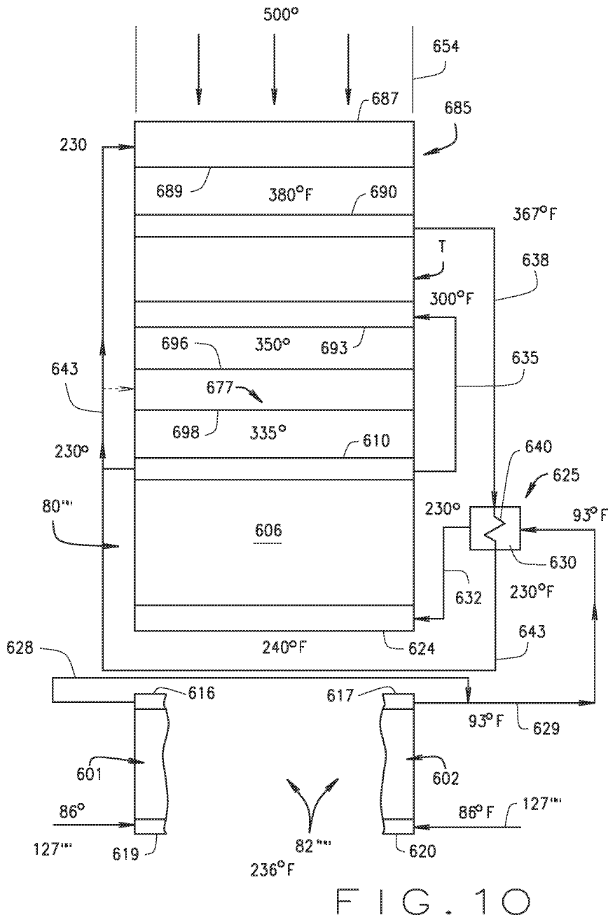

Focusing now on the FIG. 10 disclosure, FIG. 10 is like that of FIG. 6 and shows an interface with an external water-to-water heat exchanger and preheater booster coil 74, but is different in that it shows the low temperature heat exchanger 82″″′ as having two separate sections 601 and 602 mounted on opposite sidewalls 62 such as previously described as to FIG. 9. The low temperature exchanger 82″′″ is comprised of the same thermoplastic polymeric material composition as described above for low temperature exchanger 82.

The low temperature exchanger 82″″′ has two separate sections 601 and 602, each of which is mounted adjacent respective HRSG sidewalls 62 such previously discussed and illustrated in the HRSG cross-section of FIG. 9. As so mounted, the sections 601 and 602 are spaced a distance from each other so that some of the exhaust gas flows between the two sections 601 and 602. However, some of the exhaust gas flows through the two sections 601 and 602. As illustrated in FIG. 8, the cross width of each of the sections 601 and 602 can vary depending upon the desired performance characteristics.

Looking first at the exhaust gas that flows through each section 601 and 602, each section 601 and 602 has, respectively, an upstream face 616 and 617, and a respective downstream face 619 and 620. The exhaust gases from feedwater heater 80″″′ flow into each of the said upstream faces 616 and 617 of sections 601 and 602, respectively, then through the coils of low temperature exchanger section 601 and 602, respectively. Thence the exhaust gas exits through the downstream faces 619 and 620, respectively of sections 601 and 602.

Now addressing the exhaust gas that flows between the two sections 601 and 602, the exhaust gas simultaneously with the flow through sections 601 and 602, flows between the inside boundaries of sections 601 and 602. Considered together, the exhaust gas that flows through sections 601 and 602, and the exhaust gas that flows between those sections 601 and 602, comingle and both flow through outlet 59 and exit flue 67.

The preheater booster “T” comprises a coil having an upstream face 690 and a downstream face 693. The exhaust gases from HP Economizer 685 flow into the upstream face 690 through its coil and thence through the downstream face 693 to leave the preheater booster T.

As seen in the FIG. 10 schematic, the LP Evaporator 677 has an upstream face 696 and a downstream face 698. The exhaust gas leaves the preheater booster T thence flows into the LP Evaporator 677 upstream face 696, through the LP Evaporator 677, and through the LP Evaporator's downstream face 698 toward the feedwater heater 80″″′.

In FIG. 10 a water-to-water heat exchanger 625 is illustrated as located to the exterior of the HRSG duct 654. As noted earlier, use of such an external water-to water heat exchanger may be desirable in situations wherein it is desired to have a warmer temperature for the water entering the feedwater heater, or when the inlet water from the condenser is lower, or when a refurbishment is performed to add the low temperature heat exchanger to an existing HRSG unit that already has a water-to-water heat exchanger installed.

In FIG. 10 the condensate pump 52 discharges feedwater into a supply pipe 127″″′, which delivers that feedwater at a temperature of about 86° F. into the inlets near each of the downstream faces 619 and 620 of low temperature exchanger sections 601 and 602, respectively. The water passes through the low temperature exchanger sections 601 and 602, to exit at their respective outlets near their respective upstream faces 616 and 617, at a temperature of approximately 93° F. From section 601, the water then flows through pipe 628, while water from section 602 flows into a pipe 629. Pipe 628 merges into flow connection with pipe 629.

The water flows through pipe 629 into the low temperature path 630 in external heat exchanger 625 and then flows through an external exchanger outlet at a temperature of about 230° F. into a connecting pipe 632 which acts as a conduit. Pipe 632 delivers the feedwater to the tubes near the downstream face 624 of feedwater heater 80″″′.

The water/steam leaves the feedwater heater 80″′″ at its upstream face 610 and flows through a transfer pipe 635 which serves as a conduit to flow into the inlet of the preheater booster T coil at its downstream face 693 at a temperature of approximately 300° F. The water/steam flows thence through preheater booster coil T toward the upstream side thereof to exit the preheater booster coil T at its upstream face 690 at a temperature of about 367° F. From there, it flows into a transfer pipe 638 which acts as a conduit to connect with the inlet of the high temperature path 640 of external heat exchanger 625.

Within the high temperature path 640 of heat exchanger 625 the temperature of the water decreases since it loses heat to water in the low temperature path 630. At the outlet of the high temperature path 640, the water enters transfer pipe 643 at a temperature of about 230° F. Pipe 643 acts as a conduit and extends to connect with the LP Evaporator 677 at its downstream face 698, or to the downstream face 689 of HP Economizer 685. If flow is to LP Evaporator 677, then from the upstream face 696 of LP Evaporator 677, the water can flow, for example, to the HP Economizer 685.

With regard to FIG. 10 and temperatures of the exhaust gases, the exhaust gases flow from the gas turbine “G”, to enter the upstream face 687 of the last of the Upstream Coils 70, here exemplified as high pressure (HP) economizer 685. The gases enter the HP Economizer upstream face 687 and exit the HP Economizer downstream face 689 and enter the preheater booster T upstream face 690 at a temperature of about 380° F. and exit its downstream face 693 at a temperature of about 350° F. The exhaust gases from preheater booster T flow into the upstream face 696 of LP Evaporator 677 to flow therethrough. The hot gases exit the LP Evaporator downstream face 698 at what is shown as an exemplary temperature of about 335° F. to enter the upstream face 610 of feedwater heater section 606. The temperature of the hot gas exiting the feedwater heater section 606 at its downstream face 624 is about 240° F.

Thereafter, the exhaust gas flows between the two low temperature exchanger sections 601 and 602, and the exhaust gas simultaneously flows through sections 601 and 602. The exhaust gas that flows through sections 601 and 602, and the exhaust gas that flows between those sections 601 and 602, comingle to exit low temperature exchanger 82″″′ at a temperature of about 236° F.

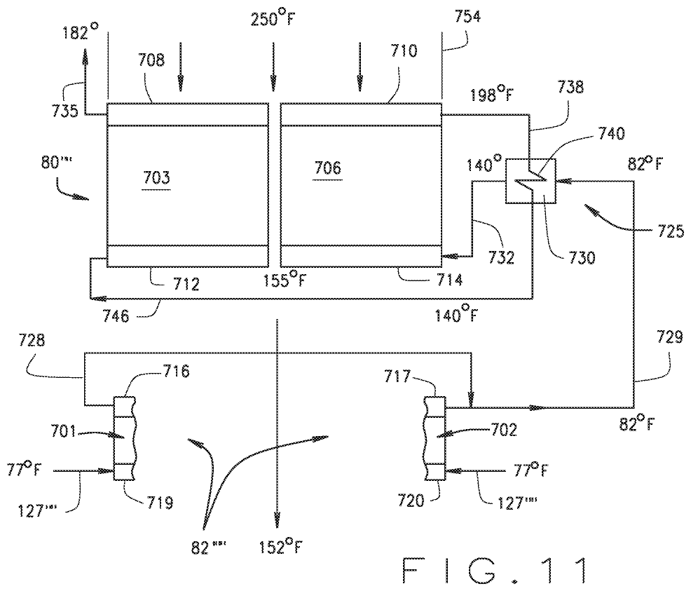

Looking now at the FIG. 11 disclosure, FIG. 11 resembles FIG. 7 as showing an interface with an external water-to-water heat exchanger, but is different in that it shows the low temperature heat exchanger 82″″′′ as having two separate sections mounted on opposite HRSG sidewalls 62. The low temperature exchanger 82″′″′ is comprised of the same thermoplastic polymeric material composition as described above for low temperature exchanger 82.

The low temperature exchanger 82″″′′ has two separate sections 701 and 702, each of which is mounted adjacent respective HRSG sidewalls 62 such previously discussed and illustrated in the HRSG cross-section of FIG. 9. As so mounted, the sections 701 and 702 are spaced a distance from each other so that some of the exhaust gas flows between the two sections 701 and 702. However, some of the exhaust gas flows through the two sections 701 and 702. As illustrated in FIG. 8, the cross width of each of the sections 701 and 702 can vary depending upon the desired performance characteristics.

Looking first at the exhaust gas that flows through each low temperature exchanger section 701 and 702, each section 701 and 702 has, respectively, an upstream face 716 and 717, and a respective downstream face 719 and 720. The exhaust gases from feedwater heater 80″″′ flow into each of the said upstream faces 716 and 717 of sections 701 and 702, respectively, then through the coils of low temperature exchanger section 701 and 702, respectively. Thence the exhaust gas exits through the downstream faces 719 and 720, respectively of sections 701 and 702.

Now addressing the exhaust gas that flows between the two sections 701 and 702, the exhaust gas simultaneously with the flow through sections 701 and 702, flows between the inside boundaries of sections 701 and 702. Considered together, the exhaust gas that flows through sections 701 and 702, and the exhaust gas that flows between those sections 701 and 702, comingle and both flow through outlet 59 and exit flue 67.

In FIG. 11 the condensate pump 52 discharges feedwater into a supply pipe 127″″″, which delivers that feedwater at a temperature of about 77° F. into the inlets near each of the downstream faces 719 and 720 of low temperature exchanger sections 701 and 702, respectively. The water passes through the low temperature exchanger sections 701 and 702, to exit at their respective outlets near their respective upstream faces 716 and 717, at a temperature of approximately 82° F. From section 701, the water then flows through pipe 728, while water from section 702 flows into a pipe 729. Pipe 728 merges into flow connection with pipe 729.

The water flows through pipe 729 into the low temperature path 730 in external heat exchanger 725 and then flows through an external exchanger outlet at a temperature of about 140° F. into a connecting pipe 732 which acts as a conduit. Pipe 732 delivers the feedwater to the tubes at the downstream face 714 of feedwater heater section 706. The water/steam leaves the feedwater heater section 706 at its upstream face 710 and flows into the high temperature path 738 of external heat exchanger 725 at a temperature of about of about 198° F. Therein it is cooled to exit into pipe 746 at a temperature of about 140° F.

Then the water flows through pipe 746 into an inlet of feedwater heater section 703 near its downstream face 712 at a temperature of approximately 140° F. The water then flows through feedwater heater section 703, then exits therefrom into pipe 735 at a temperature of about 182° F., to flow to upstream coils such as to the LP Evaporator 77 or HP economizer 85.

As to FIG. 11 and temperatures of the exhaust gases, for illustrative purposes the exhaust gases approach from upstream coils at an exemplary temperature of about 250° F. to enter the upstream faces 708 and 710 of feedwater heater sections 703 and 706. The temperature of the hot gas exiting the feedwater heater sections 703 and 706 at their downstream faces 712 and 714 is approximately 155° F.

Thereafter, the exhaust gas flows between the two low temperature exchanger sections 701 and 702, and the exhaust gas simultaneously flows through sections 701 and 702. The exhaust gas that flows through sections 701 and 702, and the exhaust gas that flows between those sections 701 and 702, comingle to exit low temperature exchanger 82″″′ at a temperature of about 152° F.

The above description has shown the flow from the low temperature exchanger coils as flowing through a conduit to a feedwater heater or feedwater heaters, and then from feedwater heater coil(s) to coils upstream thereof such as to an LP evaporator or HP economizer. Flow from the low temperature exchanger coils can also be directed through a conduit or conduits to other upstream coils therefrom, such as to an intermediate pressure (IP) economizer and/or intermediate pressure (IP) evaporator.

As noted in the aforesaid '206 Patent, sometimes a feedwater heater is referred to as an “economizer” or a “feedwater preheater”. in this application the expression “feedwater heater” not only identifies a device of that name, but also a feedwater preheater and/or an economizer located downstream in the direction of gas flow from the last boiler or evaporator in in an HRSG.

Further, the specification uses the term “low temperature heat exchanger”, though the term “low temperature preheater” coil could also be used. For example, for an oil fired system, or other system with a low pressure evaporator, or a low pressure evaporator with an integral deaerator (LPDA) but without a preheater, the low temperature heat exchanger could serve as a feedwater preheater or preheater coil.

Moreover, for a single or dual pressure system the described low temperature heat exchanger could be located in the water flow path after the condensate pump but before the high pressure (HP) or intermediate pressure (IP) boiler feed pump to act as a low temperature economizer (LTECON). Additionally, some of the water that is heated in the low temperature heat exchanger as shown in the various embodiments, can be directed through piping to other uses such as preheating cold water for district heating applications, or preheating closed loop water to enhance air temperature at the inlet of gas turbines and improve efficiency especially at partial loads.

The connections of the various discussed pipes have been described as preferably at the downstream or upstream faces of the heat exchangers such as the low temperature heat exchanger, feedwater heater sections, the preheater booster, the LP Evaporator, and the HP Economizer. However less preferably the connections of the various pipes can be otherwise near the downstream face or upstream face of such components. In all references to the various pipes, the said pipes act as conduits through which water and/or steam flow.

Changes can be made in the above constructions without departing from the scope of the disclosure, it is intended that all matter contained in the above description or shown in the accompanying drawings shall be interpreted as illustrative and not in a limiting sense.

1. A heat recovery steam generator comprising:
a casing having an inlet and an outlet and a gas flow path there between for gas flow upstream from the inlet toward the outlet downstream therefrom;
upstream coils of heat exchanger tubes, the upstream coils located within the casing downstream from the inlet;
one or more feedwater heater coils of heat exchanger tubes, the one or more feedwater heater coils located within the casing downstream from the upstream coils so that gas passing through the upstream coils can flow downstream from the upstream coils to pass through the one or more feedwater heater coils;
one or more low temperature heat exchanging coils located within the casing downstream from the upstream coils so that gas passing through the one or more feedwater heater coils can flow downstream from the one or more feedwater heater coils to pass through the one or more low temperature heat exchanging coils, the low temperature heat exchanging coils comprising a corrosion-resistant, thermally conductive graphite component-thermoplastic polymer component composite material;
a first conduit extending from flow connection with a low temperature heat exchanging coil to flow connection with a feedwater heater coil, the first conduit configured for water to flow there through from the low temperature heat exchanging coil to the feedwater heater coil; and
a second conduit extending from the one or more feedwater heater coils to one or more of the upstream coils of heat exchanger tubes, the second conduit configured to allow water to flow there through from a feedwater heater coil to one or more of the upstream coils.

2. The heat recovery steam generator of claim 1 wherein the composite material of the low temperature coils is comprised of from about 70 wt. % to about 90 wt. % of the graphite-based component and from about 30 wt. % to about 10 wt. % of the thermoplastic polymer component.

3. The heat recovery steam generator of claim 1 wherein the thermoplastic polymer component of the composite material of the low temperature coils is selected from the group consisting of polyolefins and polyaryl sulfides.

4. The heat recovery steam generator of claim 1 wherein the thermoplastic polymer component of the composite material of the low temperature coils comprises a polypropylene.

5. The heat recovery steam generator of claim 1 wherein the thermoplastic polymer component of the composite material of the low temperature coils comprises a polyphenylene sulfide.

6. The heat recovery steam generator of claim 1 wherein the composite material of the low temperature coils exhibits corrosion resistance to both water and to sulfuric acid, and mixtures thereof.

7. The heat recovery steam generator of claim 1, wherein the low temperature heat exchanging coils have an upstream face, and the first conduit exits the one or more low temperature heat exchanging coils near the upstream face of the one or more low temperature heater coils.

8. The heat recovery steam generator of any of claim 1, wherein the feedwater heater coils have a downstream face, and the first conduit exits the one or more low temperature heater feedwater heater coils near the upstream face of the one or more low temperature heat exchanging coils to extend to flow connection with the one or more feedwater heater coils near the downstream face of the feedwater heater coils.

9. The heat recovery steam generator of claim 8, further comprising a third conduit configured to extend for flow connection from the feedwater heater coils to one or more of the upstream coils.

10. The heat recovery steam generator of claim 9 wherein the upstream coils comprise a low pressure evaporator, and further comprising the third conduit being configured to extend for flow connection from the one or more feedwater heater coils to flow connection with the low pressure evaporator.

11. The heat recovery steam generator of claim 9 wherein the upstream coils comprise a high pressure economizer, and further comprising the third conduit being configured to extend for flow connection from the one or more feedwater heater coils to flow connection with the high pressure economizer.

12. The heat recovery steam generator of claim 9 wherein the upstream coils comprise preheater booster coils, and further comprising:
the third conduit being configured to extend for flow connection from the one or more feedwater heater coils to flow connection with the preheater booster coils;
a water-to-water heat exchanger positioned external to the casing and having a lower temperature path and a higher temperature path;
a fourth conduit being configured to extend from the preheater booster coils to extend for flow connection to the higher temperature path of the water-to-water heat exchanger, and
the first conduit extending from a low temperature heat exchanging coil to flow through the lower temperature path of the water-to-water heat exchanger and thence into one or more low temperature coils near the downstream face of the said one or more low temperature coils.

13. The heat recovery steam generator of claim 12 further comprising the first conduit flow path extending through the water-to-water heat exchanger and thence to a feedwater heater coil.

14. The heat recovery steam generator of claim 1 further comprising low temperature coils having two or more sections configured to be spaced from each other so that some of the exhaust gas can flow between at least two of said sections, and wherein the first conduit extends from one of said sections for flow connection to a feedwater heater coil.

15. The heat recovery steam generator of claim 14 further comprising an interconnecting conduit configured to extend for flow connection to allow flow from one said section to another said section.

16. The heat recovery steam generator of claim 12 further comprising low temperature coils having two or more sections configured to be spaced from each other so that some of the exhaust gas can flow between at least two of said sections, further comprising an interconnecting conduit configured to extend for flow connection to allow flow from one said section to another said section, and wherein the first conduit extends from one of said sections through the water-to-water heat exchanger for flow connection to a feedwater heater coil.

17. The heat recovery steam generator of claim 1 further comprising the feedwater heater coils have two or more sections, each section having a downstream face, and wherein the first conduit is configure to exit a low temperature heater feedwater heater coil near the upstream face of the low temperature heat exchanging coil to branch into flow channels which extend to flow connection with two or more of the feedwater heater sections near the downstream face of the respective feedwater heater section.

18. The heat recovery steam generator of claim 18, further comprising a water-to-water heat exchanger positioned external to the casing and having a lower temperature path and a higher temperature path, the water-to-water heat exchanger having an inlet configured to be in connection with its lower temperature path so that the first conduit can extend through said inlet and pass through the low temperature path and thence extend to flow connection with a first of the feedwater heater sections near the downstream face of said first feedwater heater section, the said first section having a conduit flowing from near its upstream face into the higher temperature path of the water-to-water heat exchanger, the higher temperature path extending to flow connection to near the downstream face of another feedwater heater section.

19. A process for heating feedwater for a heat recovery steam generator which heat recovery steam generator has:
a casing having an inlet and an outlet and a gas flow path there between for gas flow upstream from the inlet toward the outlet downstream therefrom;
upstream coils of heat exchanger tubes, the upstream coils located within the casing downstream from the inlet;
one or more feedwater heater coils of heat exchanger tubes, the one or more feedwater heater coils located within the casing downstream from the upstream coils so that gas passing through the upstream coils can flow downstream from the upstream coils to pass through the one or more feedwater heater coils;
one or more low temperature heat exchanging coils located within the casing downstream from the upstream coils so that gas passing through the one or more feedwater heater coils can flow downstream from the one or more feedwater heater coils to pass through the one or more low temperature heat exchanging coils, the low temperature heat exchanging coils comprising a corrosion-resistant, thermally conductive graphite component-thermoplastic polymer component composite material;
a first conduit extending from flow connection with a low temperature heat exchanging coil to flow connection with a feedwater heater coil, the first conduit configured for water to flow there through from the low temperature heat exchanging coil to the feedwater heater coil; and
a second conduit extending from the one or more feedwater heater coils to one or more of the upstream coils of heat exchanger tubes, the second conduit configured to allow water to flow there through from a feedwater heater coil to one or more of the upstream coils;
the process comprising the steps of:
directing water to flow from the one or more low temperature heat exchanging coils through the first conduit to the one or more feed water heating coils; and
directing water from the one or more feedwater heater coils to one or more of the upstream coils.

20. The process of claim 19, wherein the one or more low temperature heat exchanging coils have an upstream face and a downstream face, the first conduit is configured to exit the one or more low temperature heat exchanging coils near the upstream face of the one or more low temperature heater coils, and an inlet for receiving feedwater located hear the downstream face of the one or more low temperature coils, and wherein the one or more feedwater heater coils have a downstream face and an upstream face, and the first conduit exits a low temperature heater feedwater heater coil near the upstream face of the one or more low temperature heat exchanging coils to extend to flow connection with the feedwater heater coils near the downstream face of the feedwater heater coils, and a third conduit configured to extend for flow connection from the one or more feedwater heater coils near the upstream face of said feedwater heater coil to one or more of the upstream coils;
the process further comprising the steps of:
directing water to flow from the one or more low temperature heat exchanging coils through the first conduit from near the upstream face of the one or more low temperature heater coils to flow into the one or more feedwater heating coils near the downstream face of the one or more low temperature heat exchanging coils; and
directing water from the one or more feedwater heater coils near the upstream face of the one or more feedwater heater coils to one or more of the upstream coils.

21. The process of claim 19 wherein:
the upstream coils comprise one or more preheater booster coils;
the third conduit is configured to extend for flow connection from the one or more feedwater heater coils to flow connection with the preheater booster coils;
a water-to-water heat exchanger is positioned external to the casing and has a lower temperature path and a higher temperature path;
a fourth conduit is configured to extend from the preheater booster coils to extend for flow connection to the higher temperature path of the water-to-water heat exchanger and thence to one or more upstream coils;
the first conduit extends from a low temperature heat exchanging coil to flow connection with the lower temperature path of the water-to-water heat exchanger and thence to one or more feedwater heater coils;
the first conduit flow path extends through the low temperature path of the water-to-water heat exchanger and thence to one or more feedwater heater coils;
the process further comprising the steps of:
directing water from the one or more feedwater heater coils to one or more of the preheater booster coils;
directing water from the preheater booster coils through the fourth conduit to flow into the higher temperature path of the water-to-water heat exchanger and thence into one or more upstream coils; and
directing water through the first conduit into the lower temperature path of the water-to-water heat exchanger and thence into one or more feedwater heater coils.

22. The process of claim 19 wherein the heat recovery steam generator further comprises:
a water-to-water heat exchanger positioned external to the casing and having a lower temperature path and a higher temperature path;
the water-to-water heat exchanger having an inlet configured to be in connection with its lower temperature path so that the first conduit can extend through said inlet and pass through the low temperature path and thence extend to flow connection with a first of the feedwater heater sections near the downstream face of said first feedwater heater section, the said first section having a conduit flowing from near its upstream face into the higher temperature path of the water-to-water heat exchanger, the higher temperature path extending to flow connection to near the downstream face of another feedwater heater section;
the process further comprising the steps of:
directing water from the one or more low temperature heat exchanging coils through the first conduit into the lower temperature path of the water-to-water heat exchanger and thence into one or more feedwater heater coils; and
directing water from near the upstream face of the first feedwater heater section into the higher temperature path of the water-to-water heat exchanger to flow through the water-to-water heat exchanger to flow into another feedwater heater section near the downstream face of said another feedwater section.
